(19) United States
(12) Patent Application Publication
(10) Pub. No.: US 2017/0241618 A1
(43) Pub. Date: Aug. 24, 2017

(54) HEAT DISSIPATION DEVICE FOR A LIGHT DEVICE OF A MOTOR VEHICLE

(71) Applicant: VALEO VISION, Bobigny Cedex (FR)

(72) Inventor: Olivier BADIA, Bobigny Cedex (FR)

(73) Assignee: VALEO VISION, Bobigny Cedex (FR)

(21) Appl. No.: 15/440,174

(22) Filed: Feb. 23, 2017

(30) Foreign Application Priority Data
Feb. 23, 2016 (FR) 16 51471

(51) Int. Cl. F21S 8/10; F21V 19/00

(52) U.S. Cl. CPC F21S 48/328; F21V 19/005; F21Y 2115/10

(57) ABSTRACT

The invention proposes a heat dissipation device for a light device of a motor vehicle, comprising a metal support of generally planar form and at least one crimping pin intended to fix a printed circuit of said light device onto said support. According to the provisions of the invention, the dimensions of the crimping pins are independent of the thickness of the support of the heat dissipation device. Methods for assembling the crimping pins on the support, and a printed circuit on the pins, are also proposed.

The invention deals with the field of motor vehicle lighting and light signaling. In particular, the invention relates to a heat dissipation device involved in a light device of a motor vehicle, and the mechanical fixing thereof to a printed circuit.

In the field of motor vehicle lighting and light signaling, it is becoming increasingly commonplace to make use of light sources of light-emitting diode LED type. An LED is a semiconductor component, which, when passed through by an electrical current of a predetermined intensity, emits light rays. A light flux of a predetermined intensity, generally related to the intensity of the electrical current passing through the LED, can then be measured. The LED technology makes it possible on the one hand to reduce the electrical energy needs of the lighting and/or signaling devices, and on the other hand it allows the vehicle constructors to create interesting and individual optical signatures. A plurality of LEDs can for example be arranged along a curvilinear contour.

It is known practice to arrange the LEDs on a printed circuit which is advantageously linked to power supply means for the LEDs. In order to protect the components of the printed circuit, the printed circuit is generally covered by a housing. To be able to dispel the heat produced by the operation of the LEDs, it is also known practice to arrange the printed circuit which supports them, or a printed circuit which supports a driver circuit for the electrical power supply of the LEDs, directly on a heat dissipating element, for example a metal heat sink.

In order to fix a printed circuit onto a metal plate of a heat sink, it is known practice to provide openings or holes in the substrate of the printed circuit. Pins on the metal plate can pass through the holes in order to hold the printed circuit in a predetermined position. As is known, the pins are made of a piece with the metal plate of the heat sink concerned. This is done by using a stamping tool which makes it possible to deform the plate to throw up a pin therefrom. Obviously, the height of such a pin cannot be greater than the thickness of the plate from which the pin is thrown up by stamping. The height of the pin needed to hold the printed circuit in position is dependent on the height of the printed circuit. It can for example be at least 2.5 mm. This height therefore corresponds to the minimum thickness that the metal plate or steel plate must have before being stamped. Typically, the heat dissipation elements are fashioned in aluminum, which is a relatively expensive material. The use of thick plates in order to obtain, by stamping, pins of a height suitable for holding a printed circuit therefore generates both a significant cost and a significant weight. Since it is necessary to obtain a pin of a height greater than that of the printed circuit, a significant steel plate thickness is necessary to be able to throw up a pin of suitable dimensions by stamping.

The aim of the invention is to mitigate at least one of the problems posed by the prior art.

The subject of the invention is a heat dissipation device for a light device of a motor vehicle. The heat dissipation device comprises a metal support comprising at least one support portion of generally planar form and at least one crimping pin intended to fix a printed circuit of a light device onto said support. The heat dissipation device is noteworthy in that said pin is tightly fixed onto a first face of the support by brazing.

The fixing of the pin is preferably done on the support portion of generally planar form.

Preferably, the metal support is of generally planar form.

Preferably, the metal support can have a thickness which is less that the height of the pin measured relative to said first face of the support.

The printed circuit can be of the molded printed circuit or Molded Interconnect Device MID type.

The printed circuit can be of the Flexible Printed Circuit Board FPCB type.

The pin can preferably have a length, corresponding to its height relative to the support onto which it is fixed, which is greater than the thickness of the printed circuit that it is intended to fix to the support.

The support can preferably have a thickness of less than 2.5 mm.

The metal support can preferably be made of aluminum.

Preferably, the support and the pin can be made of the same materials. Alternatively, the support and the pin can be made of different metal materials.

Cooling fins can preferably be fixed onto a second face of the support by brazing. Alternatively, cooling fins can be fixed onto the first face of the support by brazing.

Another subject of the invention is a method for fixing at least one crimping pin intended to fix a printed circuit of a light device of a motor vehicle onto a metal support. The method is noteworthy in that it comprises the following steps:
generally parallel alignment of the base surface of the pin with a face of the metal support;
addition of a brazing material between the base of the pin and the face of the metal support;
brazing, at a temperature lower than the melting points of the pin and of the metal support.

Preferably, in the alignment step, a play is preserved between the pin and the face of the metal support, in order to avoid any degradation of the braze upon a subsequent crimping of the pin.

Another subject of the invention is a method for assembling a printed circuit of a light device for a motor vehicle on a heat dissipation device according to the invention. The assembly method is noteworthy in that it comprises the following steps:
alignment of at least one opening in the support of the printed circuit relative to at least one crimping pin of the heat dissipation device;
placement of the printed circuit on the support of the heat dissipation device, such that the crimping pin pierces said opening;
crimping of the pin to fix the printed circuit onto the heat dissipation device.

The crimping step can preferably comprise a step of making electrical contact between at least one electrical track of the printed circuit and the crimping pin, in order to link said electrical track to the electrical ground potential.

Preferably, the printed circuit can comprise at least one light source of the light device. It can for example be a light source with semiconductor elements such as a light-emitting diode, LED. The printed circuit can alternatively comprise a driving circuit for the power supply of at least one light source of the light device.

By using the provisions of the invention, it becomes possible to propose solutions for fixing a printed circuit onto a metal plate of a heat dissipating element, which involve thinner steel plates than the solutions known from the prior art. By fixing crimping pins to a thin steel plate by brazing, it is possible to propose pins whose height is independent of the thickness of the plate, while maintaining the seal-tightness of the joint between the pin and the plate. The result thereof is a commensurate reduction of the thickness of the steel plate, which creates savings in terms of weight and costs. Furthermore, the fixing by crimping allows the ground potential to be picked up by an electrical circuit of the printed circuit.

Other features and advantages of the present invention will be better understood from the exemplary description and the drawings in which:

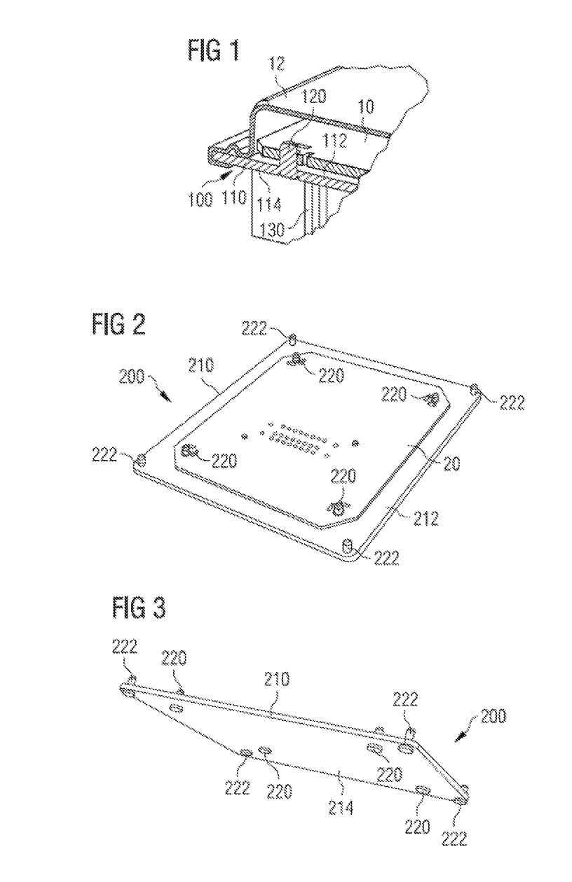

FIG. 1 is a perspective schematic illustration of a lateral cross section through a component of a light device for a motor vehicle, comprising a device according to the invention in a preferential embodiment;

FIG. 2 is a perspective schematic illustration of a preferential embodiment of the device according to the invention seen from the front, showing also a printed circuit;

FIG. 3 is a perspective schematic illustration of a preferential embodiment of the device according to the invention seen from a second face, on the side opposite the face illustrated by FIG. 2.

In the following description, similar reference numbers will be used to describe similar concepts through the different embodiments of the invention. Thus, the numbers 100, 200 for example describe a dissipation device in two different embodiments according to the invention.

Unless specifically indicated otherwise, technical features described in detail for a given embodiment can be combined with the technical features described in the context of other embodiments described in an exemplary and nonlimiting manner.

Metal brazing is a permanent assembly method that is known per se in the prior art, which makes it possible to establish a metal continuity between the joined parts. The brazing mechanism is an atomic diffusion/migration on both sides of the edges to be assembled, obtained by heat action. Unlike welding, the assembled edges are not melted in the brazing method. Typically, the brazing is done using a filler metal or a brazing product, the melting point of which is lower than that of the parts to be assembled. The choice of such a material is within the scope of those skilled in the art. For brazing parts made of aluminum, an alloy of aluminum and silicon can for example be used as filler metal. The melting point of such an alloy lies between 570° C. and 625° C. The parts to be assembled can be made of different metals or of the same metal. The brazing temperature is lower than the melting point of the parts to be assembled, but higher than the melting point of the filler metal.

The brazing makes it possible to produce tight joins between the assembled parts, the final assembly exhibiting a metallurgical and thermal continuity. The assembling of multiple parts can also be performed in parallel in an oven. Alternatively, a local heat input can be used to produce an assembly by brazing. As is known, the parts to be assembled should preferably be clean and stripped of any surface oxides, in order to guarantee the brazing effect.

FIG. 1 shows a thermal device 100 according to the invention for a light device of a motor vehicle. The light device also comprises a printed circuit 10 which supports a driving circuit for the power supply of light sources, for example of light-emitting diodes LED. The power supply driving circuit generally involves a converter circuit and produces heat. The figure also shows a housing 12 which covers the printed circuit, and which produces a tight join with the edge of the heat dissipation device. The printed circuit comprises an opening through which passes a crimping pin 120 fixed onto a portion of the face 112 of the support 110 of the heat dissipation device, said surface portion being generally planar. The crimping pin is fixed to the support 110 by brazing. It is used to hold the printed circuit in a position predetermined by the placement of the pin/pins and of the corresponding openings of the printed circuit.

As indicated in FIG. 1, the opposite face 114 of the support 110, or alternatively the face 112, can host cooling fins 130 in order to increase the surface area of the heat dissipation device which is in contact with the ambient air, thus facilitating the heat exchange. The fins are advantageously fixed to the support 110 by brazing.

In order to facilitate the heat exchange from the first face 112 which, in the example shown, supports the heat source, to the second face 114 which supports the cooling fins, it is advantageous to provide a support 110 of small thickness, i.e. less than 2.5 mm, less than 1.5 mm, or for example 1 mm. The height of the pins 120 on the side 112 is chosen independently of the thickness of the support or of the piece of aluminum plate 110. The height of the pins 120 can be high enough for the pins to pass through the openings provided in the printed circuit and emerge to allow the fixing of the printed circuit by crimping of the pins. The height of the pins 120 can for example be at least 2.5 mm relative to the face 112 of the support 110. In order to be able to perform the crimping, in which a significant mechanical stress is applied to the pin, the base thereof must be aligned with the plane of the support 110.

FIG. 2 shows a preferential embodiment of the heat dissipation device 200 according to the invention. The face 212 which supports the printed circuit 20 is shown. Crimping pins 220 have been fixed to the generally planar support 210. These pins are used to hold the printed circuit in a predetermined position, by passing through openings of the printed circuit provided for this purpose, before being crimped. In this embodiment, a second set of crimping pints 222 is provided to fix a housing thereto which can tightly cover the printed circuit. FIG. 3 shows the same embodiment as FIG. 2, but the opposite face 214 of the device 200 is illustrated. Here it is apparent that the pins 220, 222 in this embodiment pass through an opening in the support 210 and comprise a shoulder which comes to bear on the face 214 of the support 210. This arrangement facilitates the alignment of the pins relative to the planar support 210. Pins with a shoulder at one end are inserted into the openings of the support 210 provided for this purpose until the shoulder comes into contact with the face 214. In this position, the pins are oriented at right angles relative to the support and can be brazed to produce the assembly of the parts concerned.

It goes without saying that the form and the dimensions of the pins and/or of the support of the heat dissipation device can be adapted to the needs of a targeted specific application without in any way departing from the scope of the present invention.

In all the embodiments, the crimping of the pins can advantageously create an electrical contact between the top face of the printed circuit, which does not face the support 110, 210 of the device, and the heat dissipation device itself, which generally represents the zero electrical potential or the ground. When an electrical track of the circuit includes the edges of an opening of the printed circuit through which one of the crimping pins passes, this contact serves to link the electrical track concerned to the ground potential.

1. A heat dissipation device for a light device of a motor vehicle, comprising a metal support comprising at least one support portion of generally planar form and at least one crimping pin intended to fix a printed circuit of said light device onto said support, wherein said pin is tightly fixed onto a first face of the support by brazing.

2. The device according to claim 1, wherein the metal support has a thickness which is less than the height of the pin measured relative to said first face of the support.

3. The device according to claim 1, wherein the support has a thickness of less than 2.5 mm.

4. The device according to claim 1, wherein the metal support is made of aluminum.

5. The device according to claim 1, wherein the support and the pin are made of the same materials.

6. The device according to one of claim 1, wherein cooling fins are fixed onto a second face of the support by brazing.

7. The method for fixing at least one crimping pin intended to fix a printed circuit of a light device of a motor vehicle onto a metal support, wherein the method comprises the following steps:
generally parallel alignment of the base surface of the pin with a face of the metal support;
addition of a brazing material between the base of the pin and of the face of the metal support;
brazing, at a temperature lower than the melting points of the pin and of the metal support.

8. The method for assembling a printed circuit of a light device for a motor vehicle on a heat dissipation device according to claim 1, wherein the method comprises the following steps:
alignment of at least one opening in the support of the printed circuit relative to at least one crimping pin of the heat dissipation device;
placement of the printed circuit on the support of the heat dissipation device, such that the crimping pin pierces said opening;
crimping of the pin to fix the printed circuit onto the heat dissipation device.

9. The method according to claim 8, wherein the crimping step comprises the step of making electrical contact between at least one electrical track of the printed circuit and the crimping pin, in order to link said electrical track to the electrical ground potential.
